(19) United States
(12) Patent Application Publication
(10) Pub. No.: US 2004/0213982 A1
(43) Pub. Date: Oct. 28, 2004

(54) Addressable camouflage for personnel, mobile equipment and installations

(75) Inventor: Igor V. Touzov, Cary, NC (US)

Correspondence Address: IGOR V TOUZOV, 311 CASTLE HAYNE DRIVE, CARY, NC, 27519, US

(73) Assignee: Dr. Igor V. Touzov, Cary, NC (US)

(21) Appl. No.: 10/707,454

(22) Filed: Dec. 15, 2003

Related U.S. Application Data
(63) Continuation-in-part of application No. 10/707,242, filed on Nov. 30, 2003.
(60) Provisional application No. 60/319,785, filed on Dec. 16, 2002.

(51) Int. Cl. B32B 3/26

(52) U.S. Cl. 428/304.4; 428/919

(57) ABSTRACT

The invention describes novel approaches for dynamic active camouflage that may be used as personal apparel as well as shell for static installations, and mobile units. This includes, but is not limited to, air units, ground units, marine units, and submersible units. Technology disclosed in this invention allows significant reduction of weight, energy consumption, and cost. It also provides significant decrease in complexity and increase in reliability. Technology also allows true blending with ambient background that is not achievable in prior art inventions and technologies.

### CROSS REFERENCE TO RELATED APPLICATIONS

Continuation in part of application Ser. No. 10/707,242, filed on Nov. 30, 2003, which is a regular application of provisional Patent Application No. 60/319,744, filed Dec. 1, 2002. This application is a regular application of provisional Patent Application No. 60/319,785, filed Dec. 16, 2002 which is hereby incorporated by reference in its entirety for all purposes.

### BACKGROUND OF INVENTION

State of the art of artificial camouflage experience quick development due to increased sensitivity and intelligence of detection means. Passive camouflage means such as protective coating U.S. Pat. No. 4,311,623, laminates U.S. Pat. No. 4,560,595 provide efficient contrast reduction of an article. But all similar camouflages fail to cloak objects from intelligent detectors, which is caused in parts by ability of detection means to differentiate mobile objects versus static background. New active camouflage systems intended to address this flaw. Nevertheless their designs become a target for new generation of detection means. Active microwave detectors are capable to discriminate electromagnetic images of such active camouflage means. Hyperspectral detectors provide capabilities of remote analysis of chemical composition of objects. This detection mean makes camouflaged articles easily detectable.

Wearable attached structures such as described in U.S. Pat. No. 5,274,848 provide an efficient cloaking against aforementioned detection means, since such structures composition can be selected to match the same of background, although such static camouflage elements does not provide cloaking against infrared detectors and have localized effect since they do not adjust for environmental changes.

Optical camouflage systems like U.S. Pat. No. 5,307,162 use display devices to project deceptive image for single or multiple observers. Such cloaking technique can only be applied on limited set of warfare units due to high cost of display devices and low reliability in war theater conditions. Another limitation of this system and one described in U.S. Pat. No. 6,333,726 is characteristic nearly flat shape of display elements, which makes such cloaking easily detectable by radars and active microwave detectors.

U.S. Pat. No. 5,942,716 discloses active camouflage system operating as a car airbag by deploying inflatable feature that decoys or dampers incoming projectile. Such system provides additional protection to an armored vehicle, but does not cloak it from detection means.

Dangling structures are employed in camouflage to solve cloaking in wide range of EM spectrum in U.S. Pat. No. 6,127,007.

Drawback of this approach is inability of wearier to alter camouflage appearance to track background changes.

The present invention shows a new class of active camouflage devices that characterized by small power consumption and is capable of providing effective cloaking in wide range of EM spectrum. The technology given in this invention provides true reflected and emitting spectrum of simulated background that makes the cloaked object undetectable via hyperspectral methods. Another unique aspect of this invention is irregular surface topography that mimics current background. This feature makes cloaking undetectable via radar or ladar methods. The camouflage systems of the present invention are suitable for installations, vehicles, troops, aircrafts, and marine vehicles.

This invention uses technology of addressable active materials disclosed in U.S. patent application Ser. No. 10/707,242.

### BRIEF DESCRIPTION OF DRAWINGS

FIG. 1 is continuous thermally actuated valve.

FIG. 2 is continuous electrostatic valve.

FIG. 3 is continuous electroosmotic pump.

FIG. 4 is logical pixels with variable resolution.

FIG. 5 is of implementations of displays with colored pigments.

FIG. 6 is operation of logical pixel.

FIG. 7 is thermal display device.

FIG. 8 is SAW thermal valve.

FIG. 9 is remote heat exchanger.

FIG. 10 is active addressable fiber.

FIG. 11 is diagram of operation of active fiber.

FIG. 12 is bipolar addressable active fiber.

FIG. 13 is active addressable fabric.

FIG. 14 is liquid train of distinct compounds.

FIG. 15 is active addressable element (leaf) of camouflage system.

FIG. 16 is active camouflage apparel.

FIG. 17 is adhesion control fiber.

FIG. 18 is functional fibers of active camouflage.

FIG. 19 is shape-shifting addressable fiber.

FIG. 20 is equivalent electrical schema of address transducer.

FIG. 21 is diagram of active apparel.

FIG. 22 is high voltage addressable fiber.

FIG. 23 is addressable EAP composite.

FIG. 24 is deceptive images.

### DETAILED DESCRIPTION

### Definitions

A micro particle is defines as a physical substance in a physical phase state that has a fixed volume, which is less than 10⁻¹⁴ m³.

Alogical pixal is defined as a logical element that has controllable optical properties for electro-magnetic radiation in range of wavelength from 20 micron to 300 nanometers. For applications other than tactical military vessels, planes, and vehicles, the term logical pixel has second meaning that is defined as a light controlling, electroactuated element.

A unit is defined as any physical body that needs to be concealed. The term unit may comprise, but is not limited to, vehicle, person, and static structure.

A continuous addressable active material is defined as a composite structure locations of surface of which may be addressed independently using continuous addressing. The term continuous addressable active material and its implementations were introduced in provisional U.S. patent application Ser. No. 60/319,744 and defined in U.S. patent application Ser. No. 10/707,242.

An addressable active material is defined as a composite structure locations of surface of which may be addressed independently. The term addressable active material and its implementations were introduced in provisional U.S. patent application Ser. No. 60/319,744 and defined in U.S. patent application Ser. No. 10/707,242.

An active camouflage is defined as apparatus which external appearance may be adjusted to conceal it from selected method of detection.

A resolution is defined as minimum size of appearance features.

A deceptive image is defined as appearance of the active camouflage to external observer in selected radiation spectrum.

A mobile phase is defined as liquid or gas flowing inside the active camouflage. The composition of liquid or gas may contain small fragments of other types. It may include, but is not limited to, nano- or micro-particles, colloids, or micro droplets.

A distributed controller is defined as geometrically spread controller apparatus.

A controllable property is defined as a physical property that may be modified by control signal.

A continuous addressing is defined as a way to address almost any physical location that positioned between two other physical locations using interference of at least two temporally distinct wave packets.

A mobility sensor is defined as device that provides information about relative motion of physical body or part.

A short-range sensor is defined as device that provides information about physical characteristics of physical media and or objects in direct proximity, which is less or equal 2 meters, of the device.

### DESCRIPTION

Continuous Planar Valve and Pump

The invention disclosed in this embodiment describes principle of construction of virtually continuous (in macroscopic sense of this word) controlled valve and pump apparatuses that extends in continuous path (single dimension) and or two-dimensional shape

Continuous valve apparatus has controlled permeability at any location along its surface. The fundamental difference between the subject of this invention and prior art devices is ability to change permeability of the valve at any location of its surface, which may have shapes of stripe, belt, film, and any other. Prior art valves control permeability at fixed number of predefined locations.

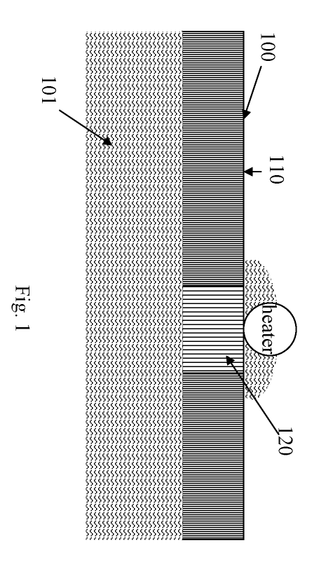

One of various possible implementations for this invention is thing film membrane. Referring to FIG. 1, membrane 100 has plurality of micro channels 110 that connect its opposite surfaces. Material of the membrane has low affinity to the liquid, which the membrane exposed to. At moderate temperature and pressure conditions this property of membrane prevents liquid from penetrating through tiny capillary channels. To allow the liquid 101 flow through desired location of the membrane surface, this location is addressed and actuated. Actuation methods include, but not limited to, thermal actuation, electroosmotic actuation, piezo actuation, electrostatic actuation, acoustic actuation, photon-acoustic actuation, etc. As an example thermal actuation is considered. It consists in heating the selected location 120 of the membrane. It results alteration of surface properties of polymer that composes the membrane and in reduction of surface tension of the liquid interfacing with that location that cause significant increase in permeability of the membrane and allows liquid to pass through.

Continuous pump apparatus has pumping speed and or capacity controlled at any location along its surface. The fundamental difference between the subject of this invention and prior art devices is ability to control pumping at any location of the surface of this pump, which may have shapes of stripe, sheet, belt, and any other. Prior art pumps have fixed number of input ports and output port at predefined physical locations.

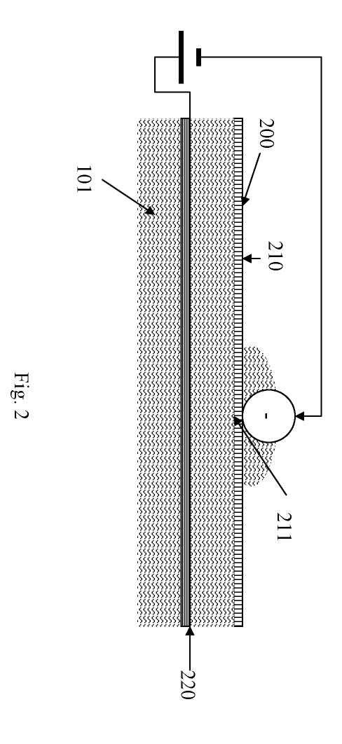

One of various possible implementations for this invention is thin film membrane as shown on FIG. 2. Membrane 200 has micro channels 210 that connect its opposite surfaces and has average diameter comparable with membrane thickness. Material of the membrane has low affinity to the liquid, which the membrane exposed to. At moderate temperature and pressure conditions this property of the membrane prevents liquid from penetrating through capillary channels, which allow maintaining noticeable backpressure on this pump. To pump liquid through desired location of the membrane this location is addressed and actuated. Actuation methods include, but not limited to, acoustic, thermal, electrostatic, photon-acoustic, etc. As and example electrostatic actuation is considered. The liquid 101 is kept at constant potential by means of electrode 220. The addressed location 211 of the membrane surface charged with potential opposite to the one of the liquid. Electric field reduces surface tension of the liquid and attracts it into capillary and pulls the liquid through it. Once charge is reduced the surface tension breaks liquid in capillary that prevents it from going back through the membrane.

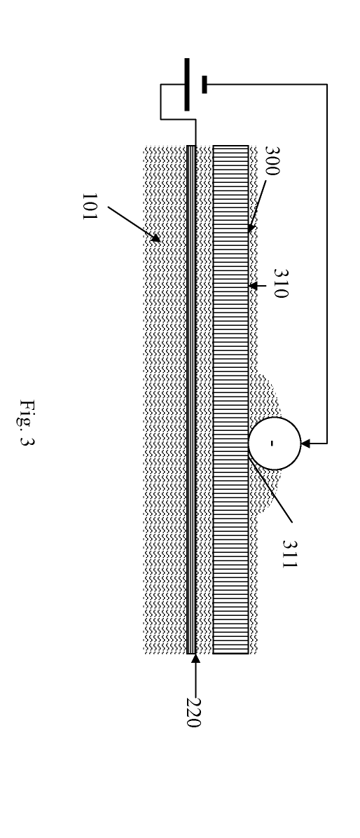

Another practical implementation of continuous pump is shown on FIG. 3. This pump uses electroosmotic effect to pump liquid through the membrane. Membrane 300 has micro channels 310 that connect its opposite. Material of the membrane has high affinity to the liquid, which the membrane exposed to. At moderate temperature and pressure conditions this property ensures that liquid penetrates on both sides of the membrane. To pump liquid through desired location of the membrane this location is addressed and actuated by localized source of electric current. The liquid 101 is kept at constant potential by means of electrode 220. The addressed location 311 of the membrane surface works as a source of electrical current. Electric field causes ions in the liquid to orderly move through the membrane in selected location. Once current stopped, natural diffusion and created backpressure cause equilibration of liquid pressure on both sides of the membrane.

These descriptions actively used technology of continuous physical addressing that was disclosed in U.S. patent application Ser. No. 10,707,242.

Variable Resolution Deceptive Image Control

This embodiment describes control algorithm that is uniquely applicable for both close-range and long-range camouflage. Control algorithms automatically change resolution of cloaking image in accordance with manual command, remote command, and or input from sensors.

Close-range camouflage requires high-resolution image on the surface of the cloaking material. This requirement may create processing overhead for controller subsystem, which causes increase in power consumption and or increase in response time.

Long-range camouflage in turn does permit lowresolution and or low-fidelity image, which may allow significant reduction in power consumption and response time.

The algorithm for control of the camouflage makes changes from close-range to long-range mode or any intermediate one. These changes may be initiated by manual command, remote command, and or be linked to sensors conditions. Examples of these conditions may include: energy resources level, ambient environment and or background data, and or unit mobility conditions.

Mobility sensors monitor unit mobility conditions and provide data about current state of the unit (location, pose, transformation, velocity, rate of motions, etc.). Control algorithm receives input from these sensors and performs deceptive image adjustment. As an example, the camouflage dynamically changes from quick response long-range mode to slow-response close-range mode when unit slows its motions. Any other behavior pattern may be programmed into standard algorithms for the active camouflage controller subsystem.

Continuously Addressable Visual Range Dynamic Camouflage

The apparatus proposed in this embodiment consist of display surface and continuous addressing layer. Dramatic decrease in complexity and cost reduction in comparison with prior art are achieved through continuous addressing layer technology described in provisional U.S. patent application Ser. No. 60/319,744 followed by U.S. patent application Ser. No. 10/707,242. This technology allows creation of large area camouflage surface with minimal number of interconnects. Camouflage material/apparatus may be tiled to cover large surfaces with segments of smaller size if desired. Technology provides unique ability of variable resolution of deceptive image. It is achieved by use of addressing pulses with variable shape.

This feature makes the invention uniquely applicable for both close-range and long-range camouflage.

The method for creation of camouflage pattern is fundamentally different from methods used in a prior art. It does not use physical pixel model for image composition.

Instead of construction of image pixel by pixel this invention uses variable size location segments-logical pixels.

The size and pattern of each segment is determined by logical pen or brush, which are created by controller subsystem.

Vector, raster, or pattern algorithms as well as any combination of those are used to create deceptive image.

Vector algorithm addresses locations of the material in arbitrary order. Controller subsystem may address single or multiple locations in parallel.

Pattern algorithm addresses groups of locations of the material in arbitrary order, and draws patterns comprising multiple locations rather then single pixel. Controller subsystem may create multiple patterns in parallel.

Raster algorithm addresses and draws locations of the material (logical pixels) in sequential order.

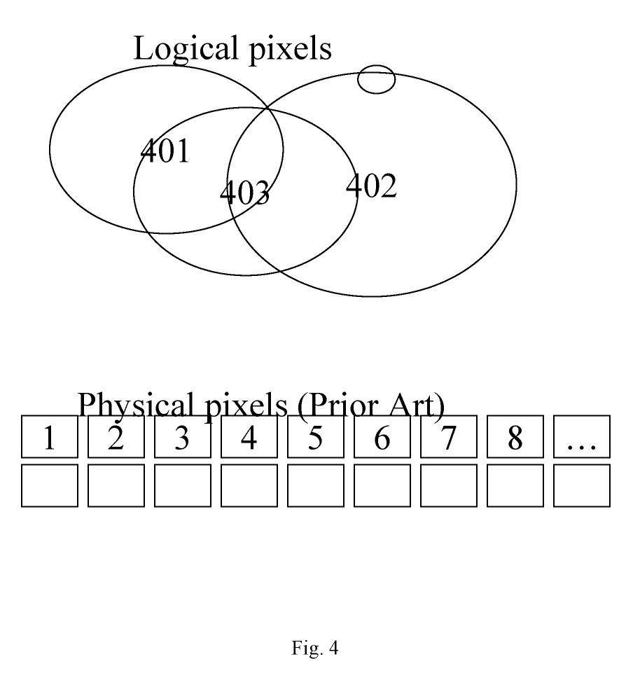

The display surface of the apparatus is a device formed by a collection of logical pixels. The physical principal in the basis of each logical pixel comprise, but is not limited to, a light shutter, LED, plasma, beads, and liquid crystal display element, sonoluminescence, multi-photon luminescence, etc. The fundamental difference between design of logical pixel with continuous design and traditional discrete pixel's design is absence of physical boundaries between logical pixels. FIG. 4 helps to visualize this concept.

At different time the same physical location may belong to different logical pixels 401, 402, 403, while physical pixels have static physical positions and sizes.

Continuous addressing layer controls the display surface.

Operations of addressing layer are governed by controller subsystem that is responsible for construction of the image.

True-color Dynamic Camouflage

The apparatus described in this embodiment consist of logical addressing layer, pressure system, display layer containing channels, and at least one mobile phase reservoir. The technology incorporated in design of this apparatus has been disclosed in details in provisional U.S. patent application Ser. No. 60/319,744 and U.S. patent application Ser. No. 10,707,242.

Spectral compositions of deceptive image of all active camouflage apparatuses disclosed in prior art are significantly distinct from spectral composition of their background. This makes them inefficient against detection devices that use hyperspectral differential spectral bands. This embodiment describes the invention that allows active camouflage to have spectral composition of deceptive image matching spectral composition of the background.

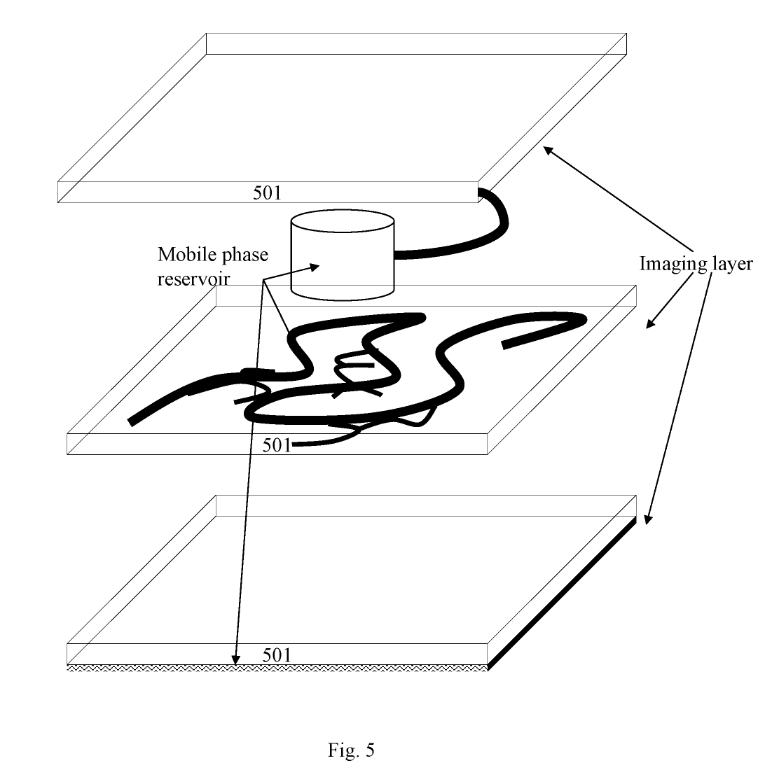

Mobile phase reservoir may be implemented as a concise storage unit that is connected to the display layer, or it may be implemented as distributed storage that forms a layer matching the display layer. FIG. 5 helps to visualize these concepts. These concepts are equally applicable without change to multiple reservoirs containing various mobile phases.

Display layer 501 consists at least one control valve or a pump, OLE_LINK1 at least one OLE_LINK1 input channel, at least one output channel and at least one optically translucent interface layer. Display layer may have an array of valves and or pumps. Valves and pumps may be implemented as MEMS devices.

Valve may be implemented as continuous stripe or two-dimensional layer with controlled permeability that is govern by continuous or discrete addressing layer.

Pump may be implemented as a continuous stripe or two-dimensional layer controlled by continuous or discrete addressing layer.

Valve or pump controls the flow of mobile phase from mobile phase reservoir to the display layer. Once in display layer the mobile phase compounds become optically exposed through the translucent interface layer.

Mobile phase may be removed from the display layer by returning it back to reservoir. This operation may be achieved by providing pressure gradient between display layer and the reservoir, and or reverse pump or by any other means.

The apparatus may have multiple display layers each dedicated to one or several mobile phase compounds.

Display layer construction has special area/pocket designed for mobile phase, which are interface with translucent layer.

This pocket may have single continuous volume or be segmented on smaller individual pockets.

This pocket may contain porous material.

This pocket may have internal surface with porous texture.

The surfaces interfacing with mobile phase may have special surface treatment.

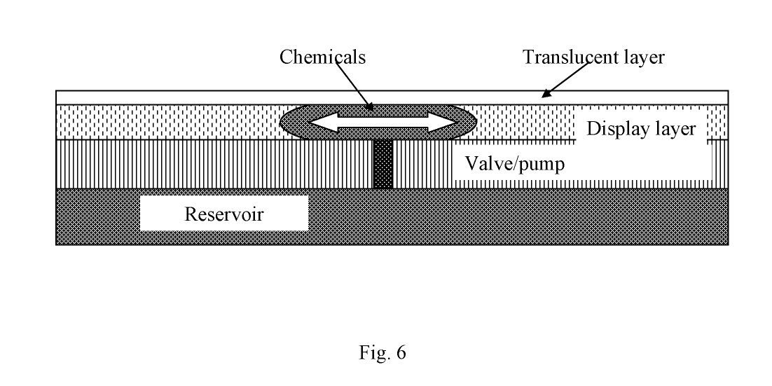

Valve or pumps are controlled through logical address layer that may be implemented in various ways. While activated, they direct flow of mobile phase between reservoir and display layer. While inside the display layer, mobile phase occupies whole pocket, or creates spot with gradually increasing or decreasing size FIG. 6. The geometry and behavior of the spot is govern by surface treatment and microstructures created on the surfaces of the pocket. In cases when pocket contains porous material, the behavior and shape of the spot is governed by geometry and properties of this porous material as well.

The composition of the mobile phase determines its optical and spectral characteristics. Controller subsystem uses logical addressing layer to generate deceptive image on display layers with specific mobile phase compositions.

Addressable Dynamic Camouflage with Black Body IR Radiation

The invention discloses technology for active camouflage for infrared detection range. This camouflage creates dynamic deceptive image of background in infrared spectrum. The fundamental difference of this invention from prior art is it ability to reproduce complete spectrum of black body radiation in its infrared part and dynamically generate deceptive image of background in infrared.

This invention provides long-lasting, lightweight, cost effective alternative to prior art alternatives. Controller subsystem allows creation of deceptive infrared image with different resolution, which may include, but is not limited to, detailed thermal pattern of background, solid single temperature pattern, mixed patterns. As an example, mixed pattern allow to create single color upper body of the unit, which matches infrared radiation spectrum of ambient air, and detailed infrared background image for the lower body of the unit, which matches ground features like hot rocks and cool grass.

Chemically Powered Active Films

The apparatus consists of chemical compounds for exothermic and or endothermic chemical reactions, distribution layer, logical addressing layer, and controller subsystem

Chemical compounds may include, but are not limited to, cobalt chloride and thionyl chloride, barium hydroxide and ammonium chloride, sodium bicarbonate and hydrochloric acid, magnesium sulfate and water, ammonium nitrate and water.

Distribution layer consists of logical channels, and logical reactor chambers.

Logical channels consist of, but not limited to, physical channels like macroscopic tubes, capillary channels, porous materials, cavities or inners space between continuous plates, etc. Logical channels transport, deliver, and or remove chemicals. Chemicals may be transported as liquid solutions, and or suspensions of particles in gas, liquid or gel (micro, or nano particles).

Logical reactor chambers consist of any of the following:

porous material, cavity, surface, etc. Chemical compounds delivered into reactor chamber may exist in any known physical form, which includes, but not limited to, mix of micro particles in gas or liquid mobile phase. Distribution layer may charge the micro particles of different chemicals to opposite electric charges. This reduces aggregation of similar particles and promotes chemical interaction of reagents in the reactor. Reactor itself may have charged surface to draw reagent micro particles to specific location.

Logical addressing layer consists of physical devices or apparatus that deterministically access single location, or predefined set of physical locations of the distribution layer. Physical implementations of addressing layer include, but not limited to, direct connection, matrix of interconnects, serial address bus, continuous addressing layer.

Controller subsystem governs operations of the apparatus. It consists of at least one digital processing unit and interface with logical addressing layer. Physical implementations of the controller subsystem may include, but is not limited to, mesh of distributed microcontrollers, central processor layout, and array of independent controllers.

The same logical distribution layer may be used to transport different chemicals during different modes of apparatus operation. This includes, but not limited to, transport of reagents for exothermic reaction during hot weather conditions and switching to transport of reagents for endothermic reaction during cold weather conditions, and transport of colored substances during day time for true-color dynamic camouflage.

Fundamental advantage of this apparatus over prior art apparatuses, which attempt to reduce temperature of a surface, is absence of discarded heat. Prior art inventions pumps the heat from one location and either accumulate it in other location for limited time or dispose it to ambient space. This limits them in either timing or creation of noticeable trace. Chemical reactions absorb heat into chemical structure of their products that have the same temperature as current temperature of the reaction. There is no heat generated in process of the compounds transport.

Active Films with Phase Transition

The apparatus consists of solid or liquid chemical compound, distribution layer, logical addressing layer, and controller subsystem.

Chemical compounds may include, but not limited to, water, carbon dioxide, Freon, etc.

Distribution layer consists of logical channels, and logical expansion chambers.

Logical channels consist of, but not limited to, physical channels like macroscopic tubes, capillary channels, porous materials, cavities or inners space between continuous plates, etc. Logical channels transport, deliver, and or remove chemicals. Chemicals are transported as liquids, and or gases.

Logical expansion chambers consist of, but not limited to, porous material, cavity, surface, etc. Chemical compounds delivered into expansion chamber experience phase transition from liquid to gas state. Expansion chamber controls the rate of expansion, and may operate in close or open mode. The close mode expansion chamber returns expanded chemicals to distribution layer. The open mode reactor conditions the gas to reach temperature defined by controller subsystem, and then disposes the gas chemicals into ambient environment.

Logical addressing layer consists of physical devices or apparatus that deterministically access single location, or predefined set of physical locations of the distribution layer. Physical implementations of addressing layer include, but are not limited to, direct connection, matrix of interconnects, serial address bus, continuous addressing layer.

Controller subsystem governs operations of the apparatus. It consists of at least one digital processing unit and interface with logical addressing layer. Physical implementations of the controller subsystem may include, but are not limited to, mesh of distributed microcontrollers, central processor layout, and array of independent controllers.

The close mode expansion chamber may operate as the reactor chamber, which was described in the previous embodiment. The same logical distribution layer may be used to transport different chemicals during different modes of apparatus operation. This includes, but is not limited to, transport of reagents for exothermic or endothermic reactions, transport of colored substances for true-color dynamic camouflage, etc.

Fundamental advantage of this apparatus over prior art devices, which attempting to reduce temperature of a surface, is absence of traces of discarded heat. Prior art inventions pumps the heat from one location and either accumulate it in other location for limited period of time or dispose it to ambient space. This limits their operation time or creates noticeable heat trace. Physical state transitions absorb heat converting it into entropy of environment, which have the same temperature as current temperature of the reaction. There is no heat generated in the process of the phase transition or expansion of the compounds.

Non-traceable Thermoelectric Active Films with Mobile Phase Heat Spreader

The apparatus consists of: array of thermoelectric elements, which does not form infrared cloaking apparatus; mobile phase distribution devices; infrared display devices; logical addressing layer; and controller subsystem. The apparatus construction includes technology disclosed in provisional U.S. patent application Ser. No. 60/319,744 and U.S. patent application Ser. No. 10,707,242.

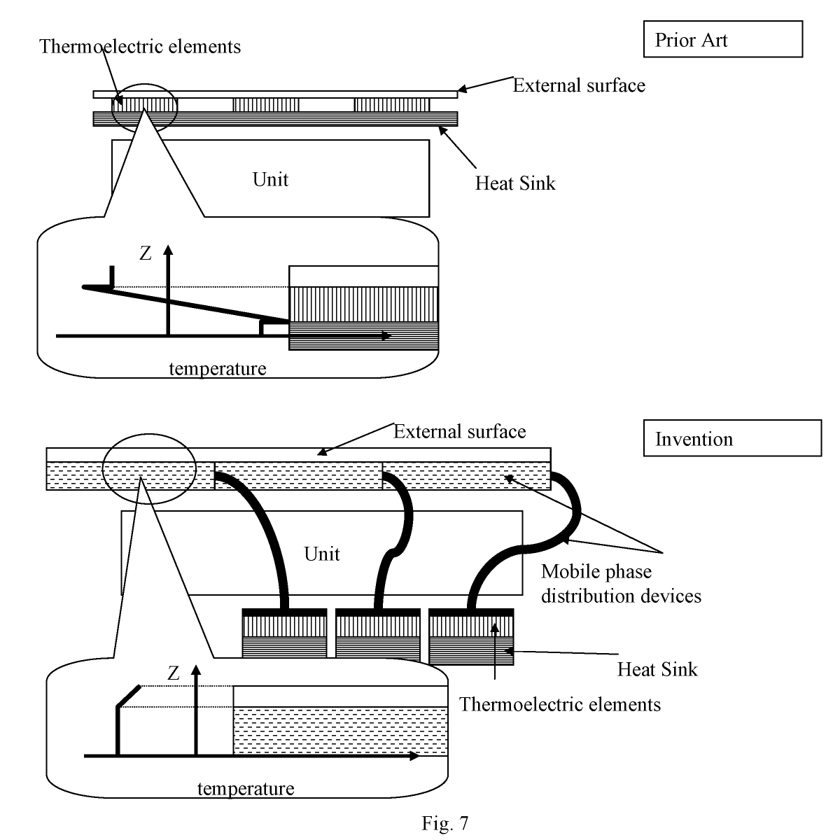

Fundamental difference of this invention from previous art inventions, which describe the use of thermoelectric modules for camouflage in infrared light spectrum, consists in the use of thermoelectric modules. In the present invention their operation does not define the deceptive image of a unit, because their location in structure of the apparatus and pattern do not correlate with the surface of the apparatus. The main reason for this fundamental change is large amount of discarded heat from thermoelectric element operating in cooling mode. This invention prevents sources of this heat to be distributed around the surface of the camouflage apparatus. Instead thermoelectric modules are placed in special location where this heat may be discarded in the most efficient way. This concept is illustrated on FIG. 7. Yet, another unique advantage this invention provides is availability of flexible designs. In prior art design thermoelectric elements restrict flexibility of camouflage layer. The Invention allows camouflage to be flexible and or elastic.

Element of thermoelectric array comprise: thermoelectric element; mobile phase heat exchange device; and heat sink device. Thermoelectric element controls the direction and or magnitude of the heat flux between the mobile phase heat exchange device and the heat sink device. Mobile phase heat exchange device performs some or all of the following functions: directs heat flux between the mobile phase and thermoelectric element, measures direction and magnitude of the heat flux, measures temperature of mobile phase, measures pressure of mobile phase, controls pressure of mobile phase, controls rate of mobile phase flow. As and example, the mobile phase heat exchange device may detect noticeable pressure loss of the mobile phase then block the mobile phase flow and disable thermoelectric element. Heat sink device performs some or all of the following functions: directs heat flux toward or away from thermoelectric element, accumulates disposed heat, redirects disposed heat, converts disposed heat, transmit heat toward thermoelectric element, produces heat.

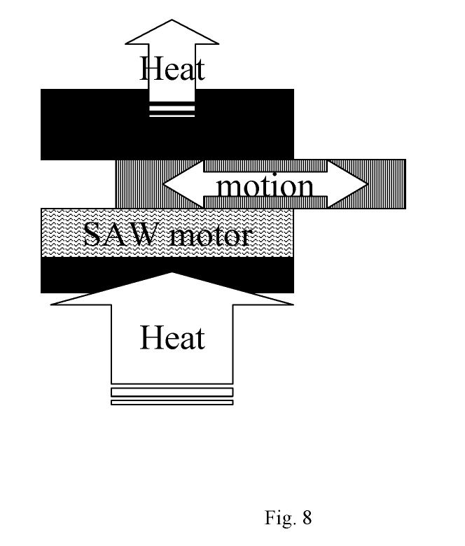

Term thermoelectric element comprises a device operating as a heat pump and or as a heat valve. This definition makes this invention fundamentally distinct from previous art inventions that use this term in meaning of heat pump only, that usually reduced to thermoelectric device based on the principle of Peltier effect. The subject of this invention may operate on the same principle, and or as eclectically controlled thermal valve, which regulates heat flux between the heat sink device and the mobile phase heat exchange device in either direction. One of possible constructions for this device is illustrated on FIG. 8.

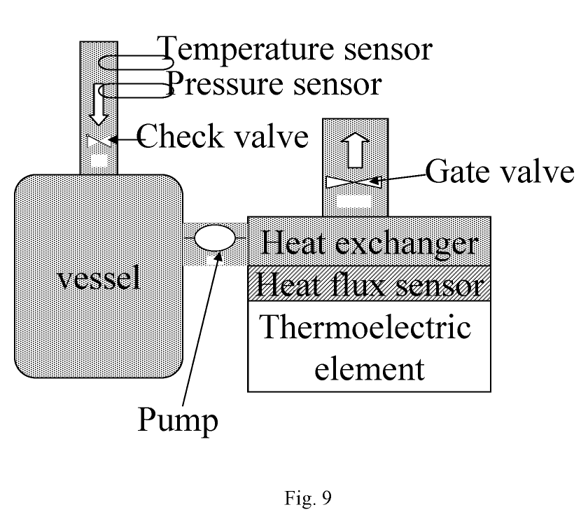

The mobile phase heat exchange device comprises, but not limited to, some or all of the following: heat flux sensor, temperature sensor, pressure sensor, mass flow sensor, flow rate sensor, flow valve, flow pump, check valve, heat pipe, heat transfer compound, tubes, etc. Example for one of the possible implementations of this device is shown on FIG. 9. The mobile phase heat exchange device delivers mobile phase to the mobile phase distribution devices.

The heat sink device comprises one or more of the following: standard heat exchanger, chemical heat converter, physical entropy converter. The standard heat exchanger is passive or active heat sink device that heat flux is to be marshaled and or dissipated. The chemical heat converter is device that utilizes chemical reactions to generate heat and or consume it. Physical entropy converter utilizes physical transformations of a substance such as physical state transitions like melting, evaporation, and sublimation, or adiabatic expansion or compression. This device may comprise, but is not limited to: vessels for storage of chemicals, reactor vessel, expansion vessel, channels, control valves, pumps, vessels for utilization of chemical products, products dump devices, etc. Advantage of this invention over traditional heat sinks is absence of heat trace of disposed heat. In open type device the temperature of used chemicals is adjusted to ambient temperature by means of heat exchange or mixing process, which uses ambient media.

The mobile phase distribution devices perform function of controlled or passive distribution of mobile phase to infrared display devices. This device may comprise, but is not limited to, controlled valves, channels, connectors, etc. The channels topology is defined by specific requirements of the apparatus operation, and may resemble: tree, star, mesh, etc. Passive design of the mobile phase distribution device does not contain controlled valves and relies on its geometry for proper distribution of the mobile phase. Active design of mobile phase distribution device uses controlled valves and or pumps to direct flow of the mobile phase. These valves and pumps may well be implemented as MEMS devices.

The infrared display devices perform functions of creation deceptive infrared image on the surface of the apparatus. The infrared display device may comprise, but is not limited to, passive heat conductor, mobile phase heat exchanger. The mobile phase heat exchanger transfers heat between the mobile phase and the passive heat conductor in either direction. The passive heat conductor creates area segment corresponding to the area segment of the apparatus's surface, which has uniform temperature distribution. The shape of this surface segment may vary to accommodate the shape of the unit or other criteria. Multiple infrared display devices may be assembled together by attaching them to a supporting film. That will create a layer or display surface for this apparatus. The methods of packaging these elements together may include, but are not limited to, use of adhesives, thermo lamination, thermo forming, welding, soldering, etc.

The logical addressing layer consists of physical devices or apparatus that deterministically access single controlled element of mobile phase distribution devices, or predefined set of such elements. Physical implementations of addressing layer include, but are not limited to, direct connection, matrix of interconnects, serial address bus, continuous addressing layer, etc.

Controller subsystem governs operations of the apparatus. It consists of at least one digital processing unit and interface with logical addressing layer. Physical implementations of the controller subsystem may include, but are not limited to, mesh of distributed microcontrollers, central processor layout, and array of independent controllers.

Photonic Films

The apparatus comprises, but is not limited to, photonic materials, surface heater layer, logical addressing layer, and controller subsystem.

Previous art inventions proposed the use of photonic materials to reduce infrared segment of body's radiation.

This approach creates infrared cloaking device that appears black in infrared imaging systems, and effectively remains high contrast object with inverse contrast. This invention discloses technology that creates infrared active camouflage apparatus, which creates infrared deceptive image of background, which makes it virtually undetectable by infrared imaging devices.

The photonic material creates a layer which blocks infrared segment of the unit radiation. This layer may be continuous, or may cloak only some segments of the unit's surface.

Surface heating layer consists of addressable active thermal material described in details in provisional U.S. patent application Ser. No. 60/319,744 and U.S. patent application Ser. No. 10,707,242. This layer is thermally insulated from the layer of photonic material and its base temperature is maintained at or below ambient temperature. This reduction of temperature may be achieved by various techniques, which comprise, but are not limited to, technologies described in previous embodiments of this document.

Logical addressing layer consists of physical devices or apparatus that deterministically access single location, or predefined set of physical locations of the addressable active thermal material. Physical implementations of addressing layer include, but not limited to, direct connection, matrix of interconnects, serial address bus, continuous addressing layer.

Controller subsystem governs operations of the apparatus. It consists of at least one digital processing unit and interface with logical addressing layer. Physical implementations of the controller subsystem may include, but not limited to, mesh of distributed microcontrollers, central processor layout, and array of independent controllers.

Controller subsystem creates thermal distribution on the surface of surface heater layer, which makes infrared deceptive image of background.

Benefits of the technology disclosed in this invention are absence of need to control temperature of the unit's surface. The surface heater layer is only weakly coupled with the rest of the apparatus, which allow it to remain at temperature close to ambient. Minor heating effect from the rest of the apparatus may be easily compensated with minimal energy expenses. This makes this apparatus very energy efficient and allows its continuous operation with autonomous energy source over long period of time, which makes it ideal for reconnaissance operations.

Reflective Films

This embodiment describes use of active camouflage for infrared spectrum in conjunction with film of material that has high index of infrared reflection. Previous art inventions has ignored the fact that energy consumption of active camouflage for infrared light may be significantly reduced by shielding the camouflage from infrared radiation of the unit. The object of this embodiment consists in use of infrared reflective film that shields the active camouflage from incoming infrared radiation to minimize its energy consumption.

Insulation Films

This embodiment describes use of active camouflage for infrared spectrum in conjunction with films of thermal insulation materials. Precious art inventions has ignored the fact that energy consumption of active camouflage for infrared light may be significantly reduced by insulating the camouflage components from direct heat transfer from the unit and from the environment. The object of this embodiment consists in use materials with low heat conductivity to shield the active camouflage from inside and outside that reduces direct heat transfer between the layers and components of the camouflage and surface of the unit as well as environment.

Sensory Subsystem

This embodiment describes the sensory subsystem, which is implicit component in all apparatuses described in above. This invention considers two classes of sensory subsystems: distributed and centralized.

Distributed sensory subsystem comprises, but is not limited to, logical sensory layer, logical communication layer, and logical processing layer. Each layer performs a specific set of operations.

Logical sensory layer comprises, but is not limited to, continuous sensors, discrete sensors, interface sensors, feedback sensors. Continuous sensors collect data from specific segment of the surface of a concealment apparatus, which includes both external interface surface and internal surfaces. Discrete sensors are located at nodes distributed thought the surfaces of the concealment apparatus and collect data specific to each node. Interface sensors collect data on background environment that directly relates to background image. Feedback sensors collect data on operational characteristics of elements of the concealment apparatus. Types of sensors comprise, but are not limited to, contact temperature sensors, noncontact temperature sensors, infrared CCD cameras, visible CCD cameras, air velocity sensors, proximity sensors, pressure sensors, colorimetric sensors, photometric sensors, motion sensors, acoustic sensors, etc.

Logical communication layer performs functions of collection and data routing between sensory elements and processing elements. Data transport technologies in this layer comprises, but not limited to, any of the following, serial buses, parallel buses, analog transmissions, digital transmissions, network protocols, digital video protocols, compression algorithms, etc. Sensory data in the concealment apparatus are routed to supply necessary information to specific location of the controller subsystem.

Logical processing layer perform function of analysis of sensory data and transformation of this data into specific signals for controller subsystem. Below is an example of operation of the distributed sensory subsystem that does not intend to restrict the invention. Contact temperature sensors are distributed throughout the surface of infrared concealment apparatus for mobile infantry. The unit wears it like full body apparel. Non-contact temperature sensory nodes are located on soils of boots. Infrared CCD cameras are located on opposite sides of a helmet. Data from soils temperature distribution pattern is captured and routed to controllers for surface segment of the camouflage with horizontal orientation. CCD data are routed to the controllers responsible for construction of deceptive background image while the unit is in mobile position. Changes in the unit position from mobile to ground are detected by proximity sensor elements, this causes the rerouting of data from contact temperature sensors correlated with proximity data to create deceptive image of the ground on exposed portion of the camouflage surface.

Data from CCD cameras are not used in this position for creation of the deceptive image, but may be continued to use as input for night vision equipment.

Centralized sensory subsystem collects data from limited number, less then one hundred, sensory devices. This subsystem comprises, but not limited to, array of sensory devices, and processing subsystem. Types of sensory devices comprise, but not limited to, visual and or infrared CCD cameras, sonar, laser scanner, etc. Data from these devices are processed in the processing subsystem and mapped to elements of deceptive image created by the concealment apparatus.

Controller Subsystem

This embodiment describes the controller subsystem, which is implicit component in all apparatuses described in above. This invention considers two classes of controller subsystems: distributed and centralized. Centralized controller comprises any type of digital processing device with required interfaces.

Distributed controller subsystem comprises network of digital processing devices with required interfaces that are distributed thought multiple locations of the concealment apparatus and are linked through digital or analog network. It will be understood by one of ordinary skill in the art that all concepts of modern distributed comporting systems may be equally applied to this network. This includes, but not limited to, redundant connections and resources, data exchange, remote execution, instructions sharing, load balancing, fault tolerance, etc.

Algorithms for Active Camouflage

All embodiments of this document that refer to creation of deceptive image contain the controller subsystem, which operates based on specific set of algorithms for image generation. It will be understood by one of ordinary skill in the art that the positional algorithmic computational means is selected from the following algorithms (reference to U.S. Pat. No. 6,333,726).

1. Projected Frame: Concealment relies on selecting a portion of the charge coupled device background frame based on estimates of distances to observers and background.

2. Projected Frame (submarine operating in shallows): Concealment relies on selecting a portion of the charge coupled device background frame based on estimates of depth from observers and background.

3. Camera Roll: Image keystoning requires correction based on a sensor that indicates true vertical.

4. Unit Roll: A misplaced horizon line can be easily identified visually, and or with data from proximity sensors. The program must compensate.

5. Unit Turn: A turn toward the observer requires a shift in image portions to the unit front.

6. Moving Morph: As the unit accelerates and changes orientation to the observer's horizon, the image shifts. As the unit change shape, the image readjusts.

7. Edge Blending: Fixed portions of the program must allow for lighter shading at unit corners to avoid dark lines.

8. Edge Diffusion: The program must allow for lighter shading at surface junction points to insure diffusion.

9. Shadow Lighting: The dark shadow underneath the mobile platform must be washed out with moderated lighting.

10. Compromise Avoidance: The guidance computer will provide input to avoid objects difficult to match.

11. Parallax: Any concealment program must calculate the effect of a moving observer on the generated image.

12. Multiple Observers: A statistical algorithm will be used to weigh multiple positional effects.

13. Background Ambient: The background light quality (reflected) must be matched by a gray-scale gradient.

14. Forward Ambient: The projected light quality (incident) must be matched to the nearest gray-scale gradient.

15. Chroma Adjustment: Basic adjustment must be made in the program for conversion of chroma to equivalent of available palette.

16. Array Learning: A separate neural network program allows the array to self-index each pixel. This eliminates the necessity of wire tracing.

Additionally this embodiment describes invention of several original algorithms: I. Carbon Copy. Unit is in close proximity to background objects. Distributed sensors map their data to opposite surface, which creates copy of underlying background on opposite surface of concealment apparatus that is exposed to observer.

II. Cold Smoke. Unit reduces temperature of surrounding air to match temperature of uniformly cold surface of the concealment apparatus.

This creates effect of dark cloud for observer with infrared vision equipment. This may be achieved by set of methods which includes, but not limited to, purging chilled vapors of water, purging chilled air, purging micro droplets of chilled liquid to form mist.

III. Fractal. Sensory data are converted into parameters for fractal structure. Deceptive image created to match this fractal structure. This algorithm is fast and allows efficient cloaking in natural landscapes, such as grass, bushes, and rocks.

IV. Pattern. Data from sensory system translated into camouflage pattern that is arrayed on the surface of the apparatus. This algorithm works extremely well for repetitive natural landscapes, like beach sand, desert, grass, and gravel.

Preferred Embodiments

This section provides detailed description of construction of active full body camouflaged apparel for military personnel. The apparel utilizes most of concepts disclosed in the previous embodiments. The purpose of following description is to demonstrate process of implementation of the present invention into finished product suitable for personal use. It will become obvious to one experienced in related art that the same process allows creation of camouflage systems for other applications as well as creation of articles that employ advantages of this invention while not presenting themselves as camouflage devises. Examples of such articles can be sport apparel and garments that actively control temperature and liquid exchange of their user.

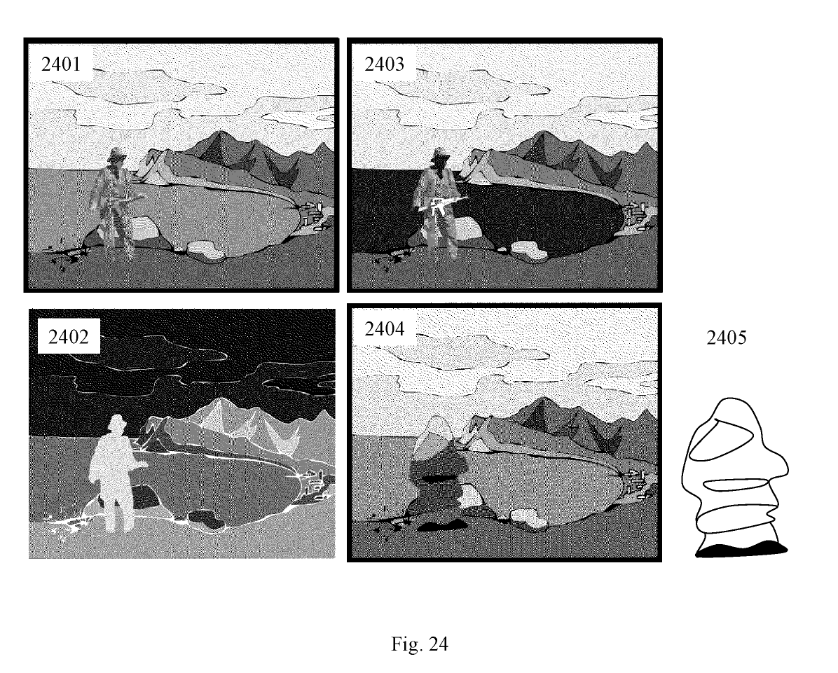

FIG. 24 illustrates some concepts detection techniques for modern camouflage. Infantry unit in standard camouflage apparel has average pattern and contrast very close to one of natural background. In some location this match is not observed and as shown on 2401 unit can be easily detected in visual means. Infrared detectors image 2402 shows even higher contrast due to IR radiation from human body. Hyperspectral image 2403 shows high contrast on some elements of munitions and unprotected body parts. Human eyes are well capable in recognition of known shapes that provide an additional detection means event in low contrast images. The present embodiment discloses shape-shifting camouflage that eliminates shape similarities and provides additional deception means. 2405 and 2404 shows appearance of the same unit wearing shape-shifting camouflage that mimics adjacent formation of boulders.

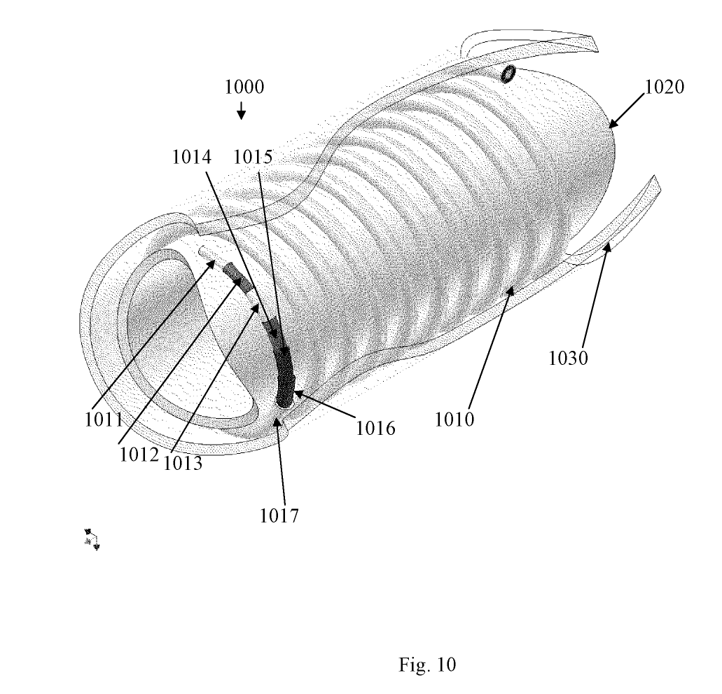

Technology employed in design of this apparel uses addressable active materials that described in U.S. patent application Ser. No. 10/707,242. FIG. 10 shows one of plurality of possible implementations of active addressable material. The principles of operation of which are disclosed in complete details in U.S. patent application Ser. No. 10/707,242. The system 1000 is active single channel fiber that represents elementary block of apparel construction. Addressable fiber 1010 shapes as a helix with pitch 200 microns. This helix confined between translucent outer tubing 1030 and opaque inner tubing 1020. Other choices are also available (inner tubing can be translucent or even colored, while outer tubing translucent in preferred EM spectrum). Outer tube 1030 has external diameter 1 mm. Addressable fiber 1010 has diameter 50 microns. Inner tube 1020 has porous walls with thickness of 50 microns and average pore size of 500 nanometers.

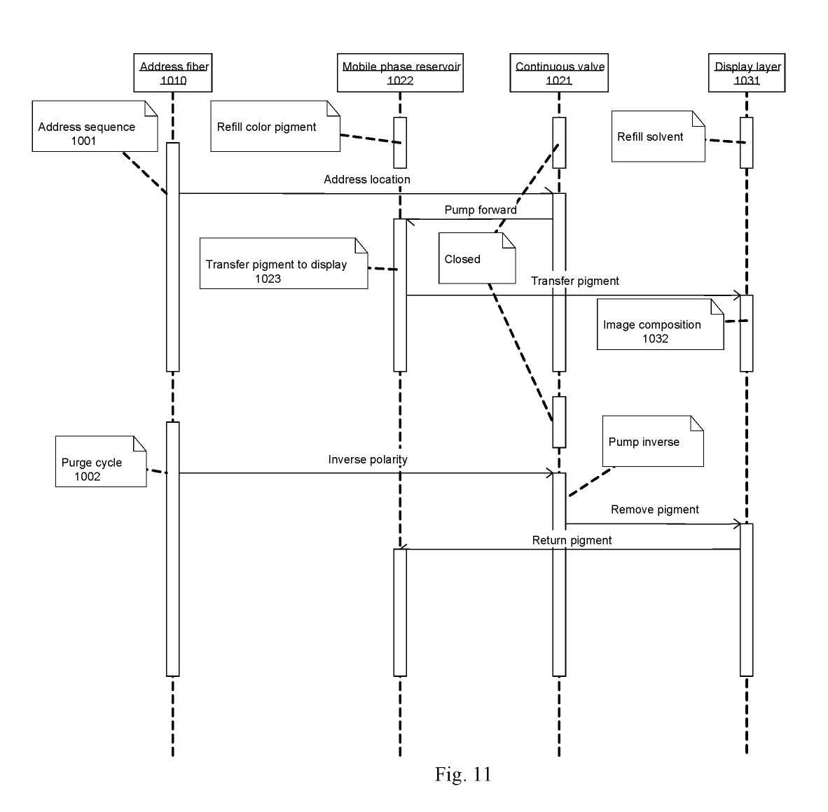

Volume between inner and outer tubes corresponds to logical display layer. Inner tubing 1020 represents mobile phase reservoir described in previous embodiments. The cycle of operation of this device is shown on FIG. 11. Referring to FIG. 10, in its initial state of the device 1000 has clear solvent placed in the volume of display layer that formed between outer and inner tubes 1030 and 1020. The same or different solvent occupies volume inside inner tube 1020. This solvent may change it composition and carry chemicals that aimed to simulate reflectance and absorbance spectrums of background. To aid initial description it is useful to assume that composition of this solvent is stationary and contains a single pigment (e.g. chlorophyll).

Outer tube can be implemented as thin wall Tygon® tube with wall thickness of 50 micron. Inner tube can be implemented as a porous PVC, polypropylene, or acrylic polymers. Addressable fiber 1010 is maintained at average potential that causes minimal electroosmotic pressure on selected pigment compound, which prevents it from self-diffusion into display volume.

The described state is shown on FIG. 11 as the initial and the final state. Referring to FIG. 11 the continuous electroosmotic valve/pump 1021 corresponds to porous walls of the inner tube in combination with outer electrode of addressing fiber and base electrode (not shown). The base electrode implementation depends on ionic strength and conductivity of selected solvent mix. It can be realized as a thin conductor placed inside the inner tube, or electrode placed somewhere in contact with inner fluid. Due to low energy requirements of the system it may be well implemented as deposited layer of carbon on inner surface of the inner tube. Use of conductive polymer material such as OLE_LINK3PEDTOLE_LINK3, or polyspirobifluorene also satisfies these requirements. Display layer 1031 consists of translucent outer film 1030 and solvent under it.

Addressable fiber 1010 is addressable one-dimensional active material with passive address layer and address transducer layer implemented as schottky junction. Referring to FIG. 10, addressable fiber 1010 has borosilicate glass core 1011, center electrode 1012 made of Cu and has thickness of 5 micron, insulator layer 1013 made of Fluorinated Ethylene Propylene that has thickness of 0.5 micron, polymetal schottky electrode 1014 with total thickness of 2.5 micron, two layers of n-type silicone 1015 undoped (10¹⁵) and 1016 doped (10¹⁹) with total thickness of 1 micron, and outer electrode 1017 made of conductive polymer material such as PEDT and thickness of 1 micron.

Due to low carrier density in PEDT and low carrier mobility in solvent, sequence of address impulses targeted to the same location causes incremental increase of ion's concentration in that location. Accumulated cross-membrane potential creates electroosmotic current through porous walls of the inner tube 1020. Direction of the current is defined by polarity of the address impulses and composition of the solvents.

Referring to FIG. 11, address sequence 1001 directs sequences of address impulses to specific locations along the device. This results in build-up of localized cross-membrane potential, which causes electroosmotic pump action. This action produces 1023 flow of pigment from reservoir 1022 to display 1031. Collection of this flows in distinct locations results in accumulation of the pigment in display area that corresponds to composition of image 1032.

In absence of address sequence, said image undergoes slow degradation that is caused by diffusion of the pigment in display layer. The rate of such diffusion can be constrained by use of thickening additives to the solvent in display layer, placing gel or porous media in display volume, or by segmenting it on isolated cells.

The rest state electroosmotic pressure causes gradual removal of the pigment from display volume to reservoir 1022. This rate can be adjusted as needed. In one scenario composed image can be quickly reset by means of purge signal 1002 that inverse polarity of addressing fiber, which cause significant electroosmotic pressure pumping the pigment back to the reservoir 1022. Such signal can be used in situations when fast change of display image is required. In other cases gradual adjustment of the image is more preferable solution that requires minimal power utilization.

Each selective addressing operation takes 100 ns per meter of the system length. In assumption that addressing operation target single side of the display surface, the systems with said geometry have 5×10³ addressable segments per meter. To individually address all these location the system will require 0.26 ms per meter. Concentration of the pigment compound in each location can be controlled through amplitude of addressing impulse or can be incremented through repetitive addressing of said location.

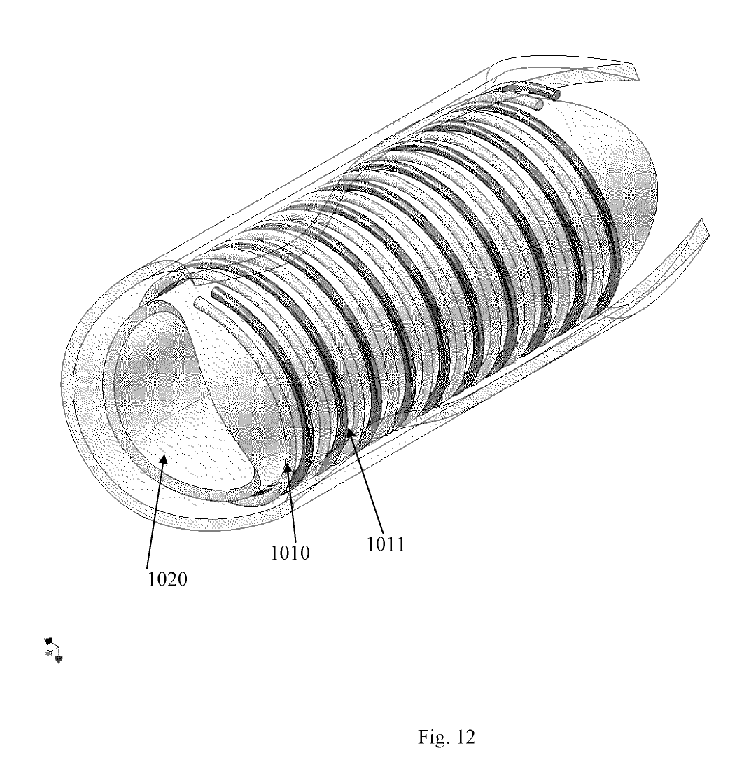

The system 1000 uses small reverse electroosmotic current to compensate for diffusion of the pigment, which in turn requires periodic updates of the composed image. Such design requires some energy to support event static display image. To create energy independent image display the system 1000 can be altered to use address transducer that supports bipolar addressing pulses, or second addressing fiber can be added as shown on FIG. 12.

Referring to FIG. 12, addressing fiber 1011 interleaved with the first addressable fiber 1010. The fiber 1011 is similar to the fiber 1010, but has different address transducer. The transducer has schottky diode structure with p-type silicone, which allows reverse polarity of addressing impulse. In this design the volume between these two fibers is filled with porous polymer material that effectively prevents diffusion of the pigment. Said material can be chosen to have low affinity to said pigment, which eliminates their adhesion. Sending addressing impulse by one of the fibers results in transition of the pigment to display volume at specified location. The addressing impulse through another fiber sent to the same location removes the pigment back to reservoir volume. Such design allows energy independent operations of the display layer when no image changes are required.

Inner reservoir of the tube 1020 in previous description was used for static storage of specified solution. Alternatively it can be utilizes as a transport tubing that delivers different solutions and components to said system. In limited set of applications that have moderate or low speed requirements for composition of display image, the same tube 1020 can deliver alternative pigments to construct single image. In trivial example of visual range image said tube can carry red, green and blue pigments sequentially and these pigments are selectively transferred to display volume to compose single image. In this example required time to build the image defined by the time it takes to replace pigments in the tube 1020. Additionally external source of specified solutions and pressure source is required. Such requirements can be easily implemented in case of static installation when there are now requirements in runtime changes of the image.

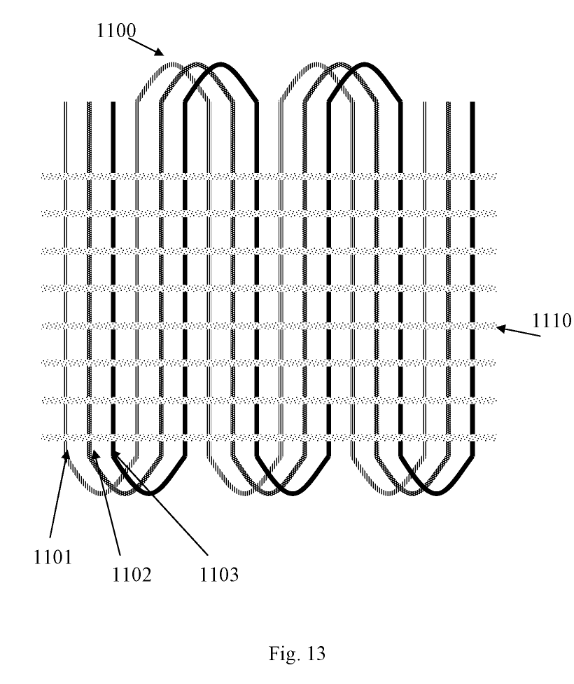

The system 1000 represents a single fiber or line in composite deceptive image. It can be integrated in two-dimensional material by means of standard textile process when said fibers 1000 forms vertical strands and linking fibers of traditional natural or synthetic materials hold them together. Referring to FIG. 13, schematic diagram of described fabric 1100 shows the layout with three independent active addressable fibers 1000. These fibers 1101, 1102, and 1103 are arranged in parallel pattern. Each fiber is individually addressable and contains solutions of different compositions. Fibers are hold together by intersecting horizontal strings 1110. Fabrics like 1100 allow quick and energy efficient composition of dynamic two-dimensional images. It is obvious to one experience in art of textile design and production that shown layout is just a schematic representation and wide variety of alternative layouts can be manufactured as well, taking in consideration high flexibility and elasticity of active fibers 1000.

Said fibers 1000 can be integrated in design of existing fabrics. Lycra® fabric can be used as on of such examples, resulting in textile material with high mechanical durability and elasticity.

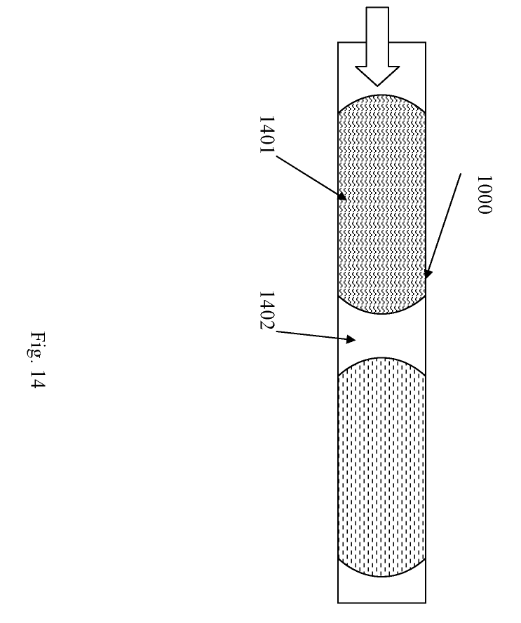

Referring to FIG. 14, fiber 1000 can be employed to transport droplets of distinct chemical solutions 1401 separated by immiscible liquid 1402. The motion of liquid through the fiber is synchronized with addressing operations. The volume of the display layer receives chemicals from distinct solutions that results in controlled chemical reaction. As an example one solution can contain be sodium carbonate and another acetic acid. Chemical interaction results in generation of carbon dioxide gas, which causes controlled extension and expansion of targeted segments of the fiber. Layout of holding fabric can be selected to provide specific geometrical response to fiber deformation. Said operation results in geometrical deformation of said textile material.

To achieve similar effect addressable fiber can be coupled with address transducer that converts address impulse into heat or deformation of PZT like material. The produced heat results in formation of bubbles. Bubbles as well as PZT deformation or other heat induced deformation result in active controlled shape shift of said fabric material. This approach allows said active addressable fabric dynamically take virtually any shape.

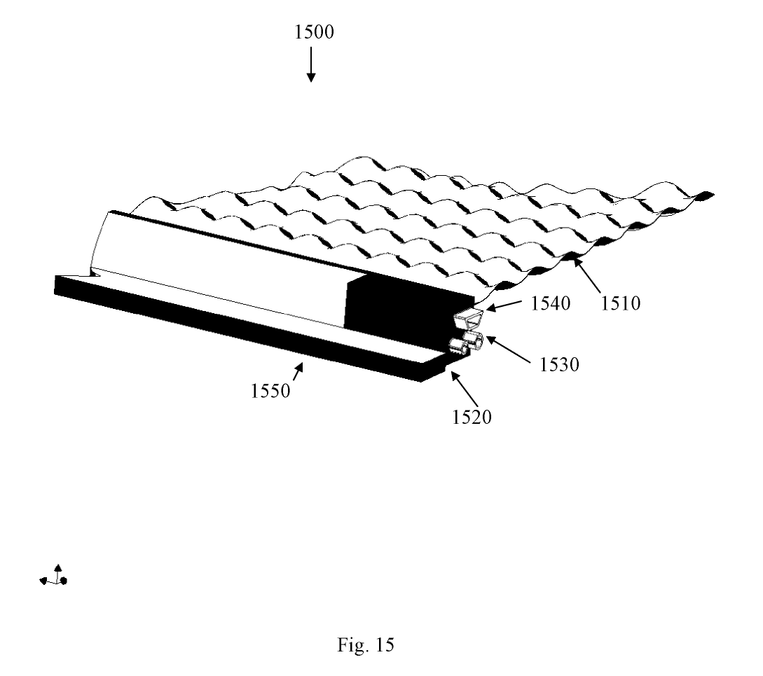

FIG. 15 shows a variant of leaf segment 1500 made of said fabric (not to scale). In its relaxed form ratio of surface area to shape area for this fabric is 5.6. This ratio for sphere is only 4.0, so said fabric has extra available surface to simulate even more complex shapes. Numerous folds of fabric are stabilized by active fibers. Controlled expansion of these fibers causes shape shift of the fabric and allows simulation of numerous natural surfaces. At least one edge of said fabric 1510 has connection to interface module 1520. Interface module provides reliable fluidic or pneumatic connections 1530 and fiber optical or electrical connection 1540 to the rest of the system. The leaf 1500 has reinforced polymer edge 1550 that provides a simple way to attach it with the rest of the system.

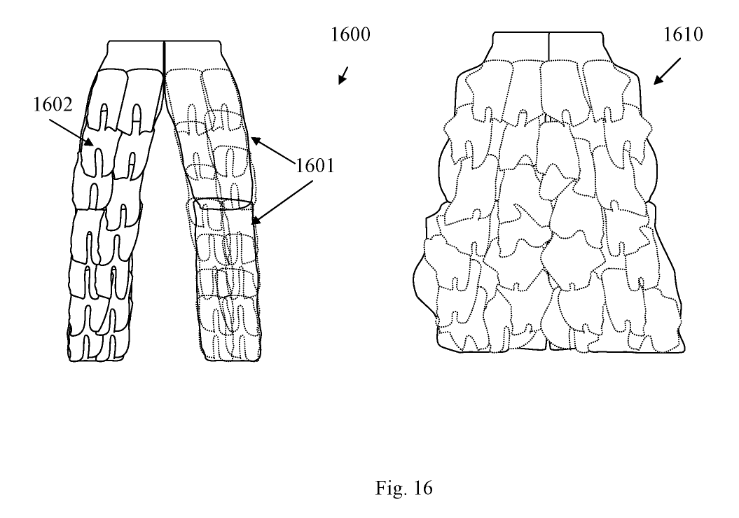

The size of the leaf is limited by required to response time and desired shape complexity. In case of camouflage apparel the whole system comprises several dozen leafs forming overlaid fractal like layout. Example of pants piece of said apparel is shown on FIG. 16. Apparel 1600 formed by optional base structure (not shown) and overlaid leafs. Inner leafs 1601 have large surface area and form complete layer with partially overlaid structure. The first layer serves as a base support for next layer of overlapping leafs 1602. Leafs of outer layers have smaller area than supporting inner leafs. Multilayer design provides faster response in shape shifting operations as well as adds redundant camouflage capabilities that increase reliability of the apparel by allowing continuous operations event when some of the leafs are nonfunctional. During shape shifting the inner layers provide low resolution image of deceptive background and transforms into large scale shape features. The outer layers append created image with higher resolution patterns or image fragments and add up fine details to the shape. Conformation 1610 sows simulation of standalone boulder that has imitated mold and algae spots.

Structure of leafs incorporate active fiber aid for various purposes. Some of these types are: image forming fibers with display layer; shape shifting fibers with addressable geometry changes; thermal pattern fibers that host addressable exothermic or endothermic reactions; adhesion control fibers; etc.

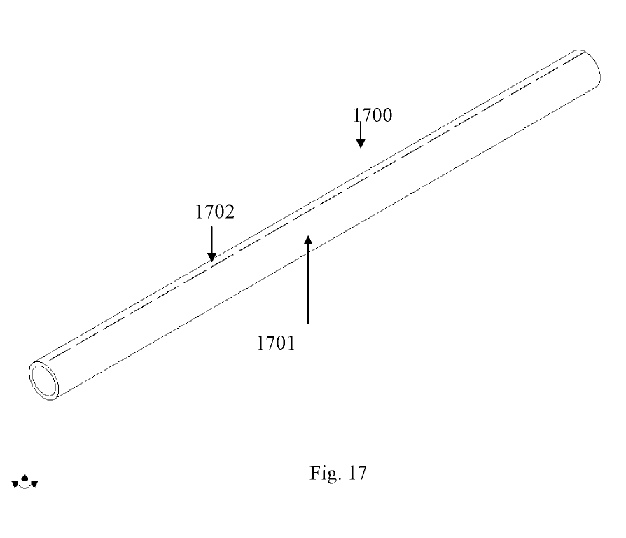

Adhesion control fiber 1700 is a micro tube with porous or partially porous walls. The sample of this tube is shown on FIG. 17. Butyl rubber tube 1701 with 1 mm outer diameter has micro incisions 1702 made at periodic distance along its length. The tube delivers to its surface either soluble organic adhesive or solvent of one. When adhesive is exposed to the surface of the fiber it promotes adhesion of dust or dirt particles. Chemical composition of these particles matches background environment. The source of said particles can be secured at runtime or said particles can be accumulated from surrounding air. Camouflage surface this way become covered with thing layer of chemicals that are natively identical to local background environment. This prevents hyperspectral discrimination of camouflage surface from native background. Content of this camouflage dust layer can be removed by purging solvent through these fibers. Solvent causes deterioration of adhesive strength and removal of dust layer. Example of adhesive component is natural plant pectin that quickly polymerizes when water solvent evaporates. Such adhesive deteriorates in light alkali solutions.

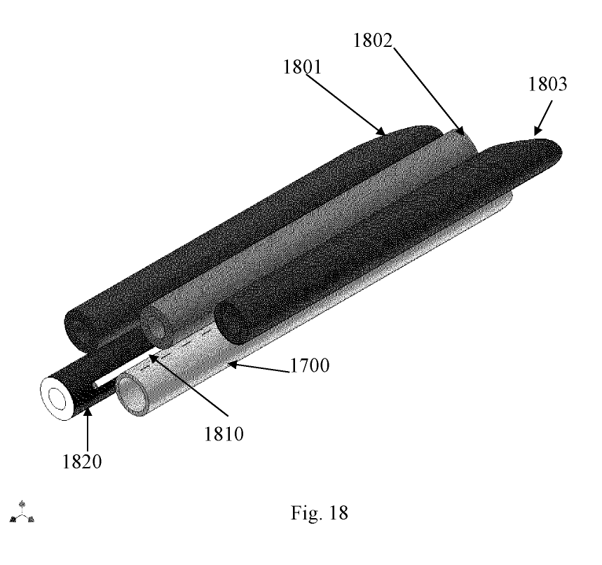

Referring to FIG. 18, composition of the fabric used in construction of said camouflage apparel comprises aligned groups of different types of active fibers 1000. Shown example has colored pigmented fibers 1801, 1802, and 1803. Each fiber has display layer and can be used to expose composite image formed by colored chemicals imitating spectrum of current environment. Addressable thermal sensor fiber 1810 reports temperature distribution along the group of fiber, as it was described in U.S. parent application Ser. No. 10/707,242. Fiber 1820 conveys endothermic or exothermic addressable reactions that create desirable thermal pattern along the fiber group. Adhesion control fiber 1700 controls contamination of said fiber group by dust particles. Each group of fibers may contain one or more shape-shifting fibers. These fibers are not shown in FIG. 18.

Fiber 1820 can produce gas as a result of chemical reaction. As an example reaction of sodium bicarbonate with acids is endothermic reaction resulting in generation of carbon dioxide gas. This gas can be disposed through porous walls of inner tube of the fiber or pores can be created on outer tube so the gas will be disposed in outer space.

Alternative algorithm of thermal image composition comprises a fiber the inner core of which conveys controlled endothermic reaction that uniformly decreases temperature of the fiber. Said reaction can involve interaction between micro particles of chemical compounds suspended in gas or inert liquid. Interactions between particles can be controlled via their electrical charge. The core of the fiber comprises two half tubes with common separating membrane. Controlling potential of these halves the rate of reaction can be adjusted. Thermal image is composed by means of resistive address transducer that increases temperature of the fiber in desired pattern.

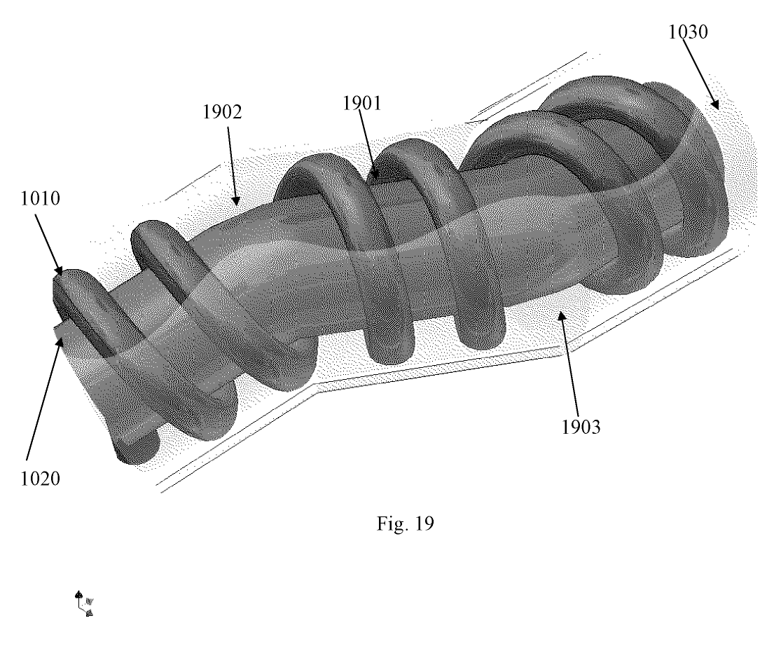

Each of addressable active fibers 1000 in addition to its primary function as described early can perform shape-shifting functions. This concept is illustrated on FIG. 19.

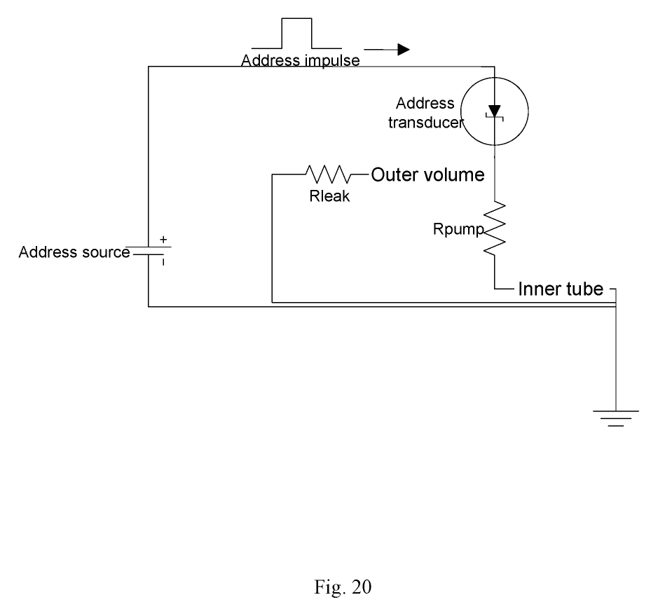

Referring to FIG. 19, this picture shows fiber that construction is identical to one shown on FIG. 10. Volume limited by coils of address fiber 1010, inner tube 1020, and outer tube 1030 filled with large cell porous conductive polymer 1901. The structure of said pores resembles closed cell foam. The average size of foam cells exceeds separation distance between inner and outer tubes. This results in cells that are open in direction normal to the tubes surface but closes in direction of address fiber 1010. Equivalent electrical schema of this fiber 1000 is shown on FIG. 20. Localized address impulse delivers to specific location along the address fiber 1010, where it leaks into ambient solution through address transducer layer. The ambient solution restricted by cells of foamed polymer 1901. The walls of inner tube 1020 have thickness of 50 microns and large number of pores. Potential of liquid inside inner tube is taken as ground level since it is controlled by conductive inner surface of tube 1020. Electroosmotic flow is induced through the walls of inner tube 1020. Electrical resistance Rₚᵤₘₚ associated with this flow comparatively small due to small wall thickness. Part of electrical charged delivered by address impulse will dissipate through adjacent areas of walls of inner tube but current density will drop exponentially with distance from addressed location. Said leak current associated with integral resistance Rₗₑₐₖ, that normalized over unit area of the tube and larger that Rₚᵤₘₚ.

Referring back to FIG. 19, said electroosmotic flow of liquid through the walls of the tube 1020 results in uneven pressure increase in location of addressed foam cells, thus resulting in bending of the fiber assembly 1000. Address operations for multiple locations such as 1902 and 1903 allows controlled bending of the fiber in multiple places and in controlled directions. If addressing impulses have wide target length that exceeds perimeter of the fiber that addressing operation will result in controlled extensions of various segments of the fiber 1000.

Similar result of controlled geometry of the fiber can be achieved when inner tube 1020 is replaced with filament of ionic polymer gel, ionomeric polymer-metal composite, conductive polymer and carbon nanotubes, or other structure capable to providing ion mobility and diffusion.

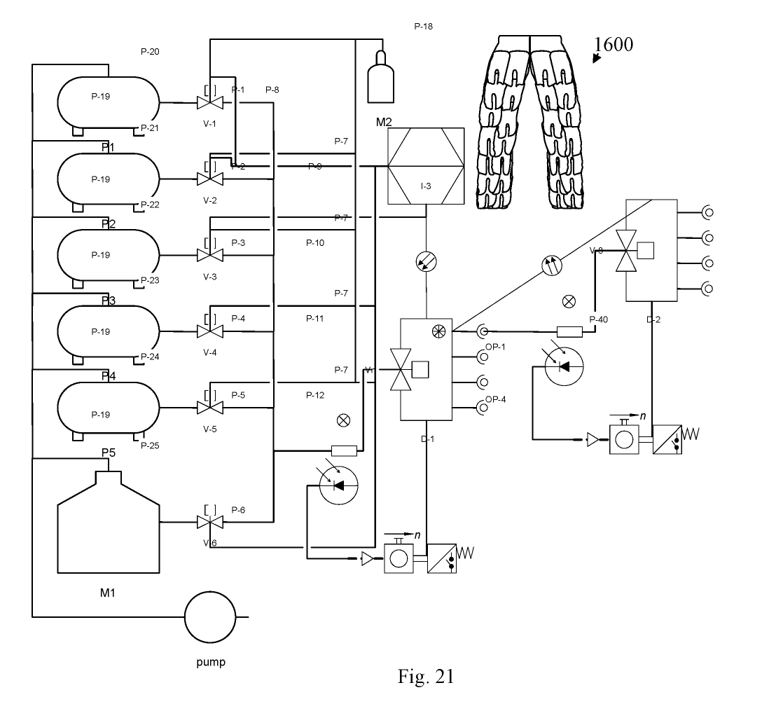

Schematic of described camouflage apparel is shown on FIG. 21. This diagram shows functional relations between principal components of this advanced suit. Discrete central components of this diagram may be placed in belt, chest, shoulder, or boots segments of the suite. Small containers of concentrated compounds P1-P5 holds library of functional camouflage pigments. This library can be restocked with chemicals that are most common suitable for expected warfare theater location. Capacity of each reservoir is defined by the diameter active fibers and overall complexity of planned operation. Due to high concentration of said chemicals in many cases 10 ml reservoir is sufficient for ten complete replacements of pigments in the suite.

Some of reservoirs P1-P5 can be charged with chemicals aid for production of endothermic or exothermic reactions that used to create deceptive thermal images. As an example the use of sodium bicarbonate saturated solution can be employed to compose thermal deceptive image in cool weather conditions. Endothermic reaction has efficiency of 0.3 kJ/g that is comparable with energy efficiency of high-end alkaline battery (0.7 kJ/g). Benefits of active addressable thermal fiber that hosts described chemical reaction are: very low weight, since whole structure comprises mostly thin-wall polymer materials; absence of heat transmission passes, since heat is consumed at exact desired location and there is no waist heat generated. In comparison, prior art inventions employ thermoelectric modules utilizing Peltier effect. Addition of weight of thermoelectric modules, copper wiring, heat sinks, and hardness resulted in total weight efficiency less that 0.1 kJ/g.

Mobile phase reservoir Ml contains water that has multipurpose applications and can be used as a source of drinking water. This reservoir has significant capacity ˜1L that explained by its combined functions. The water functions as a primary solvent in the apparel system, and also employed to adjust concentrations of other chemicals, and to transport them to the camouflage leafs 1500. Secondary reservoir of immiscible mobile phase M2 that employed as a spacer to separate segments of liquid train during their delivery to leafs. This spacer mobile phase can be chosen from gas or liquid, and in case of liquid can be distinctly colored to aid optical detection.

Chemicals from reservoirs are pumped to common channel P-8, where each of them mixed with primary mobile phase in specific proportion. The process of mixing and delivery is controlled by individual valve devices V-1 through V6. These mixes are partitioned by secondary mobile phase introduced in between. This layout results in liquid train where each mix resides in separates segment. Digital controller unit 1-3 controls operations of the valves. Each fundamental piece of the apparel such as pants, jacket, helmet, etc. has as least one connector/ distributor module that establish hydraulic and signal connection with described central elements. Such module is shown as D-1. Module D-1 receive fiber-optical link from central controller and performs synchronous processing of the liquid train. It uses electric, magnetic, or optical detector to identify spacer sequence of the train. Embedded valves perform redirection of train segments to specific output ports OP-1 trough OP-4. Each leaf 1500 establishes liquid and optical connection with corresponding distribution device. Each inner leaf hosts similar distribution device that chains the connections to upper layers of leafs. This layout resembles tree structure, where damage to upper level of leafs does not affect operations of lower levels. Optical fibers provide high-fidelity data link of leafs with central controller.

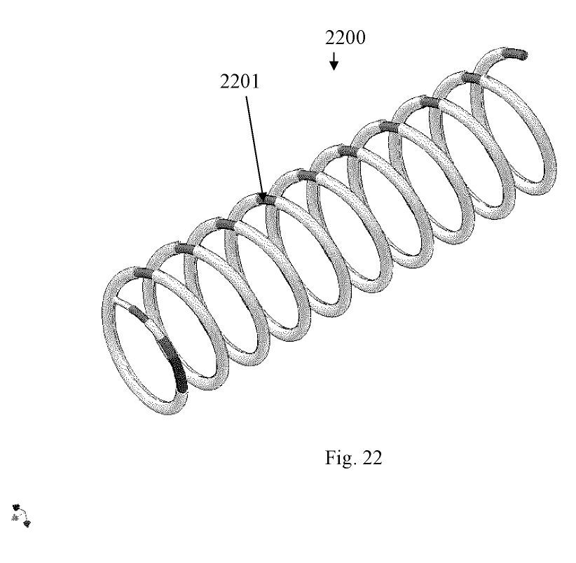

Previous embodiment in its entirety relies on operations of active addressable fibers. Following embodiment describes alternative composite material structure that may be employed as a shape shifting elements of described leaf structures Instead of ionic electro-active materials it uses electronic electro-active polymers. Fundamental distinction between these two types of shape actuators is requirement of significantly higher driving voltage to drive electronic EAP. Address fiber with modified address transducer structure is shown on FIG. 22. This fiber is analogous in all aspects to one shown on FIG. 10. The difference resides in structure of address transducer layer that instead of silicone employs SiC semiconductor structure of Schottky Barrier diode. As it was shown in industrial publications such structures has reverse blocking voltage from one to five kilovolts. To improve energy efficiency off such address transducer structure it has gaps 2201 that separate individual coils. With blocking voltage of 3 kV the address fiber 2200 can supply 1.5 kV address impulse that will be localized to individual loop.

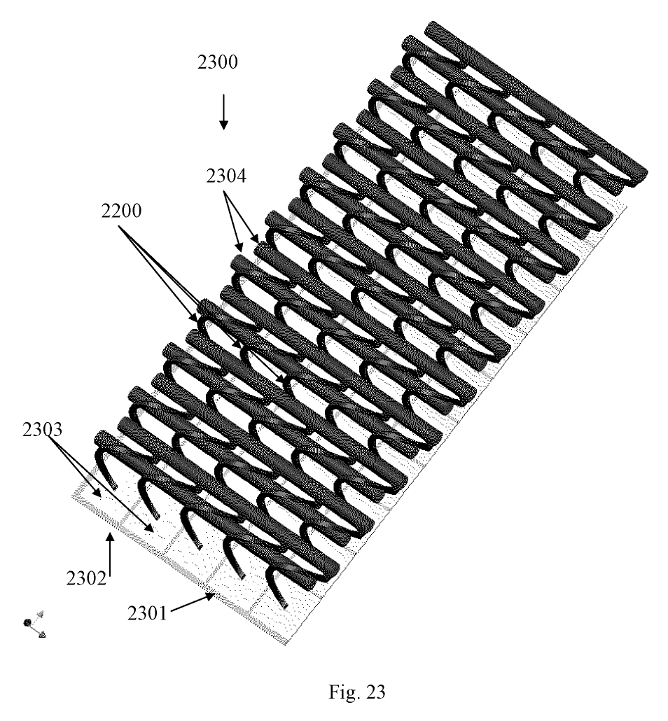

FIG. 23 shows schematic view of patterned EAP integrated with fabric material containing high-voltage addressable fibers 2200. Film of EAP material 2301 has one common elastic electrode 2302 deposited on one side that covers full surface of the polymer. Other side has pattern of elastic electrodes 2303. High voltage address fibers 2200 are geometrically bound by elastic nylon strings 2304 that forms two-dimensional fabric. This fabric is adhered to patterned surface of EAP in a way that each loop of the address fibers contacts with individual top electrode of patterned surface. Adhesion is enforced by glue of any other means. Resulting composite material reveals addressable shape-shifting behavior. The pattern show does not have to be rectangular since other patterns are equally functional. Address fibers can be individually accessed or be a sites of single address fiber.

Material 2300 in addition to shape-shifting can be used as a topography sensor. While placed on uneven surface various segments of EAP experience deformations resulting in alteration of material thickness. This results in changes of capacity of associates patterned electrode with respect to the common electrode. Sending address impulses to sequence of locations will results in sequence of current pulses through common electrode of EAP. The amplitude of these pulses is reversely proportional to capacity of each of the pattern electrodes, thus directly proportional to curvature of surface at associated location. Collecting data of surface curvature for all or selected set of pattern locations allows to reconstruct current topography of layer formed by EAP 2301.

This sensor can be employed as an element of described camouflage apparel, and be used as input for “carbon copy” camouflage algorithm. The user of apparel places piece of fabric 2300 on surface of natural feature he would like to mimic. Topography data are reflected as corresponding shape-shift pattern on apparel surface. Such algorithm can be automatically employed when user sits or lies on the ground. In this situation the part of apparel contacting ground works as a sensor while its opposite surface mimics ground's topography.

1. A concealment apparatus comprising continuously addressable material as a means of adjusting its appearance.

2. A concealment apparatus that uses chemical reactions involving electrically charged micro particles.

3. A concealment apparatus or a composite material that comprises a channel to transport micro particles.

4. A display device that dynamically produces an image and where in spectral composition of said image comprises spectrum of a chemical compound location or amount of which in said image dynamically controlled.

5. A thermoelectric device that uses surface acoustic waves (SAW) motor to control propagation of heat.

6. A concealment apparatus comprising a unit equipped with active camouflage, wherein said camouflage adjusts its appearance according to conformation of the unit.

7. A concealment apparatus comprising an active camouflage, wherein said camouflage creates deceptive images with variable resolution, and said resolution has as least two values one of which at least twice coarse than another.

8. A concealment apparatus comprising an active camouflage with at least one tube or channel that transports defined mobile phase from one physical location to another.

9. A concealment apparatus of claim 8 that controls temperature of at least one surface, wherein said surface is outer surface or inner surface that covers at least 1/10 of spatial angle around a unit that uses said apparatus.

10. A concealment apparatus comprising a unit equipped with active camouflage that uses photonic materials and dynamically composes infrared patterns or images.

11. A concealment apparatus comprising a unit equipped with active camouflage, wherein surface of said camouflage is elastic, and wherein term elastic stands for ability to elongate at least 10% in at least one dimension.

12. A concealment apparatus comprising continuous addressing as a means of gathering data about physical objects.

13. A concealment apparatus of claim 12, wherein said data correspond to infrared and thermal appearance of background.

14. A concealment apparatus of claim 12, wherein said data correspond to topography of background.

15. A concealment apparatus comprising a unit equipped with active camouflage that uses means of sensing background appearance, wherein said means are short-range sensors.

16. A concealment apparatus comprising a unit equipped with active camouflage that uses mobility sensors and adjusts appearance based on data gathered from said sensors.

17. A heat sink device that converts received heat into energy of chemical bonds produced in endothermic chemical reaction.

18. A concealment apparatus that uses physical phase transition to convert heat into entropy.

19. A concealment apparatus comprising means of adjusting apparent geometrical shape, wherein said shape-shifting is driven by addressable active material.

20. A composite material that is capable of actively changing its shape, wherein said shape is dynamically selectable and controllable using continuous addressing.

21. A composite material of claim 20, wherein said composite comprises electro active polymer.

22. A composite material of claim 20, wherein said composite comprises electro active polymer, wherein said polymer is acrylic polymer.

23. A composite material of claim 20, wherein said composite comprises electro active polymer, wherein said polymer is silicone rubber.

24. A composite material comprising a waveguide that shaped as a helix. and said waveguide is laid out in pattern of parallel rows.

25. A composite material of claim 24, wherein said waveguide is laid out in pattern of parallel rows.

26. A composite material of claim 24, wherein there are multiple said waveguides laid out in pattern of parallel rows.

27. A composite material of claim 24, wherein said waveguide integrated in fabric-like material.

28. A composite material comprising an electro active polymer and continuous addressing, wherein said material provides topographical information about shape it currently has.

29. A concealment apparatus comprising means to capture dust or dirt particles from ambient environment.

30. A concealment apparatus of claim 29 further comprising means of removal of said particles.

31. A concealment apparatus that uses “cold smoke”.

32. A concealment apparatus that uses “Carbon Copy” algorithm.

33. A concealment apparatus that uses “Fractal” algorithm.

34. A concealment apparatus that uses “Pattern” algorithm.

35. A structure comprising an element with aspect ratio greater that 20 in at least one dimension, wherein said element has natural or artificially created pores or channels, and wherein said channels or pores connects at least two surfaces of said element. Wherein said surfaces are opened into at least two distinct non-overlapping volumes. And said element is employed to manipulate passage of mobile phase from one of said volumes into at least one other volume, and area or location of a region said mobile phase passes through belongs to at least one of said surfaces, said region can be dynamically changed in controlled manner.

36. A structure of claim 35 that further utilizes electroosmotic effect to control flow of said mobile phase.

37. A structure of claim 35 that further employs continuous addressing to control said region.

38. A structure comprising a cylinder of polymer material and a waveguide that forms helix concentric with said cylinder and tangential with its surface, and said cylinder has height that at least ten times of its width.

39. A structure of claim 3 38 wherein said cylinder is hollow (tube).

40. A structure of claim 3 38 wherein said polymer is a component of electro active material.

41. A structure of claim 3 38 wherein said cylinder is hollow (tube), and said structure is capable of actively changing its shape, wherein said shape is dynamically selectable and controllable using said waveguide.
